(19) United States
(12) Patent Application Publication
(10) Pub. No.: US 2023/0130502 A1
(43) Pub. Date: Apr. 27, 2023

(54) ENTITY CLUSTERING

(71) Applicant: PayPal, Inc., San Jose, CA (US)

(72) Inventors: Yaotian Zou, Milpitas, CA (US); Aaron A Trube, Omaha, NE (US); Xu He, Pleasanton, CA (US)

(21) Appl. No.: 17/451,760

(22) Filed: Oct. 21, 2021

(51) Int. Cl. G06F 16/28

(52) U.S. Cl. CPC G06F 16/288

(57) ABSTRACT

Computer software architectures are disclosed that use improved machine learning techniques for data science and data clustering. Computer operations are improved by more efficiently and effectively processing relevant data. Based on a clustering model, initial clusters of taxonomical pairs of entity classifications and entity sub-classifications using taxonomical-level textual data representative of one or more aspects of electronic transactions associated with the taxonomical pairs can be determined, wherein the clustering model has been generated based on machine learning applied to past clusters of past taxonomical pairs of entity classifications and entity sub-classifications other than the initial clusters of the taxonomical pairs, and iteratively refining the initial clusters, according to a similarity criterion, resulting in tuned clusters.

### TECHNICAL FIELD

The disclosed subject matter generally relates to computer software architectures for data science and data clustering, and more particularly to machine-learning based improvements for entity clustering using natural language processing techniques and iterative techniques, according to various embodiments.

### BACKGROUND

Conventionally, a system can access a group of data points and determine variance in the group. Based on such variance, a conventional system can then divide the data points into sub-groups. However, such conventional systems are limited to primitive variance-based data division functions that ignore other features associated with the data points. Further, conventional systems do not make changes to the variance-based data division functions, meaning that accuracies associated with the conventional systems are low and do not natively increase.

### BRIEF DESCRIPTION OF DRAWINGS

FIG. 1 is a block diagram of an exemplary system in accordance with one or more embodiments described herein.

FIG. 2 is a block diagram of an exemplary system in accordance with one or more embodiments described herein.

FIG. 3A illustrates exemplary clusters and associated information in accordance with one or more embodiments described herein.

FIG. 3B illustrates an exemplary cluster map in accordance with one or more embodiments described herein.

FIG. 4 is a flowchart of exemplary entity clustering in accordance with one or more embodiments described herein.

FIG. 5 is a block flow diagram for a process for entity clustering in accordance with one or more embodiments described herein.

FIG. 6 is a block flow diagram for a process for entity clustering in accordance with one or more embodiments described herein.

FIG. 7 is a block flow diagram for a process for entity clustering in accordance with one or more embodiments described herein.

FIG. 8 is an example, non-limiting computing environment in which one or more embodiments described herein can be implemented.

FIG. 9 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, entity clustering can be improved in various ways, and various embodiments are described herein to this end and/or other ends.

Various embodiments herein can leverage machine-learning-based models in order to generate clusters of taxonomical pairs of data using one or more aspects of the data. Further, various embodiments herein can iteratively refine clusters of data. The foregoing can enable generation data clusters with increased accuracies, which can be utilized in various embodiments herein.

With a growing volume of merchants onboarding and/or relying on payment processing entities, the need for payment processing entities to better manage and engage with merchants also increases. For instance, merchant revenues are often industry-correlated. Thus, it can be beneficial to generate clusters of merchants based on key information, such as industry/sub-industry, size, region, overall industry/sub-industry overall volume growth/decline, and/or other factors. Homogeneous clusters (e.g., of entities such as merchants) can be utilized to generate insight into specific business domains, as well as how merchants perform relative to peer merchants and competitors. A better understanding of merchants and relative performance can help develop more in-depth, personalized, and proactive insight into merchant successes and growth opportunities. For example, clusters herein can comprise one or more of: (1) similarity or correlation in industry descriptions; (2) similarity or correlation in an industry monthly payment volume trend; and/or (3) a sufficient quantity of entities (e.g., merchants).

Embodiments herein can utilize iterative and stepwise approaches to determine an optimal quantity of clusters, such that the clusters can be generated to satisfy defined similarity metrics (e.g., in industry description and/or volume trend). In this regard, cluster sizes can be initialized, and then continuously divided until cluster sizes reach defined threshold(s) (e.g., based on similarity metric(s)). Such defined thresholds can be industry specific, determined using machine learning, or otherwise defined (e.g., in a lookup table). Industry description(s) can be utilized to generate initial clusters, and then industry total payment volume (TPV) trends can be utilized in order to further divide clusters into smaller clusters (e.g., sub-clusters). Metrics for identifying similarities in industry description and/or volume trends can comprise, for example, cosine similarity, a Pearson correlation coefficient, or other suitable metrics.

According to an embodiment, a system can comprise a processor, and a non-transitory computer-readable medium having stored thereon computer-executable instructions that are executable by the system to cause the system to perform operations comprising determining, based on a clustering model, initial clusters of taxonomical pairs of entity classifications and entity sub-classifications using taxonomical-level textual data representative of one or more aspects of electronic transactions associated with the taxonomical pairs, wherein the clustering model has been generated based on machine learning applied to past clusters of past taxonomical pairs of entity classifications and entity sub-classifications other than the initial clusters of the taxonomical pairs, and iteratively refining the initial clusters, according to a similarity criterion, resulting in tuned clusters.

In various embodiments, determining the initial clusters of the taxonomical pairs can comprise clustering vector representations of the taxonomical-level textual data generated using a natural language processing function.

In one or more embodiments, iteratively refining the initial clusters can comprise iteratively refining the initial clusters using binary clustering until data representative of an aspect of intracluster similarity of the one or more aspects of the electronic transactions within a cluster is determined to satisfy a defined intracluster similarity threshold.

In further embodiments, an entity classification of the entity classifications can be associated with respective industry data representative of a high-level description of respective entity operations, a sub-classification of the sub-classifications can be associated with respective sub-industry data representative of a low-level description of respective entity operations, and the initial clusters of the taxonomical pairs can be determined based on the industry data and the sub-industry data.

In some embodiments, an aspect of the one or more aspects of the electronic transactions associated with the taxonomical pairs can comprise periodic transaction volume data representative of periodic transaction volume associated with the taxonomical pairs.

In various embodiments, the above operations can further comprise excluding a taxonomical pair from the initial clusters when respective operational parameter data of the taxonomical pair is determined not to satisfy a defined operational parameter data threshold.

In additional embodiments, the above operations can further comprise removing a tuned cluster from the tuned clusters when a quantity of entities associated with one or more of the taxonomical pairs represented in the tuned cluster is determined to satisfy a defined taxonomical pair removal threshold.

It is noted that, in some embodiments, the above operations can further comprise assigning an excluded taxonomical pair to a tuned cluster of the tuned clusters using respective taxonomical-level textual data associated with the excluded taxonomical pair and a cosine similarity criterion determined to be threshold-satisfied by the excluded taxonomical pair and the tuned cluster.

In one or more embodiments, the above operations can further comprise generating a cluster map based on the tuned clusters and entity-level textual data associated with the one or more aspects of the electronic transactions associated with an entity represented in the taxonomical pairs.

In another embodiment, a computer-implemented method can comprise clustering, by a system comprising a processor and based on a clustering model, vector representations of taxonomical pairs of entity classifications and entity sub-classifications using taxonomical-level textual data representative of one or more aspects of electronic transactions associated with the taxonomical pairs, resulting in initial clusters of the taxonomical pairs, wherein the clustering model has been generated based on machine learning applied to past vector representations of past taxonomical pairs of entity classifications and entity sub-classifications other than the vector representations, and iteratively refining, by the system and according to a similarity criterion, the initial clusters to generate tuned clusters.

In various embodiments, clustering the vector representations of the taxonomical pairs can comprise clustering, by the system and using a K-means clustering algorithm, the vector representations of the taxonomical pairs.

In additional embodiments, iteratively refining the initial clusters to generate the tuned clusters can comprise applying, by the system, vector representations of the one or more aspects of the electronic transactions as input for a K-means clustering algorithm with a cluster size set for binary clustering.

In some embodiments, iteratively refining the initial clusters to generate the tuned clusters can comprise iteratively refining, by the system, using binary clustering until data representative of an aspect of intracluster similarity of the one or more aspects of the electronic transactions exceeds a defined intracluster similarity threshold.

In one or embodiments, the above method can further comprise excluding, by the system, a taxonomical pair from inclusion in the initial clusters when respective operational parameter data of the taxonomical pair is determined not to satisfy a defined operational parameter data threshold.

In further embodiments, the above method can further comprise determining, by the system, a quantity of entities associated with a set of taxonomical pairs of a tuned cluster of the tuned clusters, and removing, by the system, the tuned cluster from the tuned clusters when the quantity of entities is determined, by the system, not to satisfy a defined quantity threshold.

In various embodiments, the above method can further comprise generating, by the system, the taxonomical-level textual data, wherein generating the taxonomical-level textual data comprises aggregating, by the system, entity-level textual data descriptive of a plurality of entities associated with the taxonomical pairs.

It is noted that, in some embodiments, the above method can further comprise assigning, by the system, an excluded taxonomical pair to a tuned cluster of the tuned clusters using respective taxonomical-level textual data of the excluded taxonomical pair and a cosine similarity metric determined to be threshold-satisfied by the excluded taxonomical pair and the tuned cluster.

In yet another embodiment, a computer-program product can comprise a computer-readable medium having program instructions embedded therewith, the program instructions executable by a computer system to cause the computer system to perform operations comprising applying vector representations of taxonomical-level textual data, representative of one or more aspects of electronic transactions associated with taxonomical pairs of entity classifications and entity sub-classifications, as input to a clustering model to obtain initial clusters of taxonomical pairs, wherein the clustering model has been generated based on machine learning applied to past vector representations of past taxonomical pairs of entity classifications and entity sub-classifications other than the vector representations, and iteratively refining the initial clusters, according to a similarity criterion, resulting in tuned clusters.

In some embodiments, the above operations can further comprise iteratively refining the initial clusters to generate the tuned clusters using Pearson correlation coefficient(s) computed using the one or more aspects of the electronic transactions.

In further embodiments, the above operations can further comprise assigning an excluded taxonomical pair to a tuned cluster of the tuned clusters using respective taxonomical-level textual data of the excluded taxonomical pair and a cosine similarity metric determined to be threshold-satisfied by the excluded taxonomical pair and the tuned cluster.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

It should be appreciated that additional manifestations, configurations, implementations, protocols, etc. can be utilized in connection with the following components described herein or different/additional components as would be appreciated by one skilled in the art.

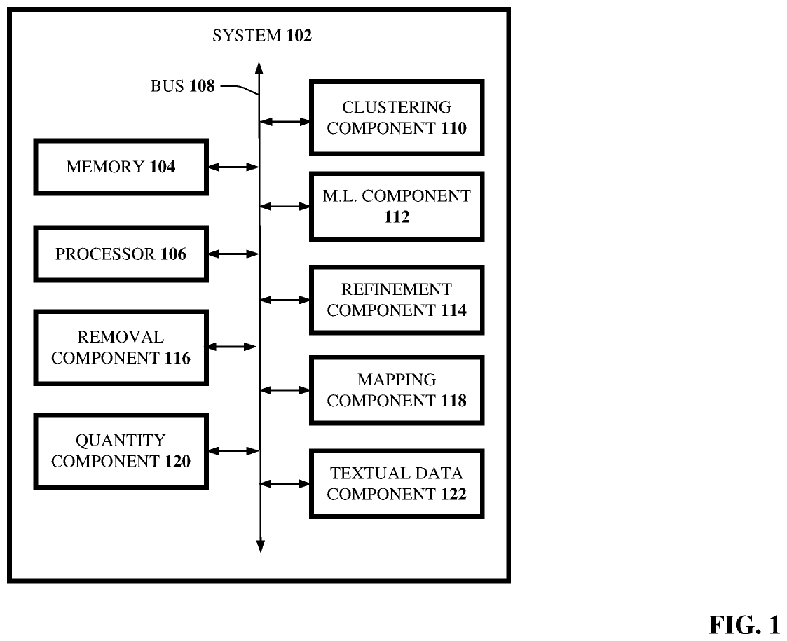

Turning now to FIG. 1, there is illustrated an example, non-limiting system 102 in accordance with one or more embodiments herein. System 102 can comprise a computerized tool (e.g., any suitable combination of computer-executable hardware and/or computer-executable software) which can be configured to perform various operations relating to entity clustering. The system 102 can comprise one or more of a variety of components, such as memory 104, processor 106, bus 108, clustering component 110, machine learning (M.L.) component 112, refinement component 114, removal component 116, mapping component 118, quantity component 120, and/or textual data component 122. It can be appreciated that the system 102 and/or various respective components can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.) The system 102 and/or various respective components can additionally comprise various graphical user interfaces (GUIs), input devices, or other suitable components.

In various embodiments, one or more of the memory 104, processor 106, bus 108, clustering component 110, machine learning (M.L.) component 112, refinement component 114, removal component 116, mapping component 118, quantity component 120, and/or textual data component 122 can be communicatively or operably coupled (e.g., over a bus or wireless network) to one another to perform one or more functions of the system 102.

According to an embodiment, the clustering component 110 can determine initial clusters of taxonomical pairs of entity classifications and entity sub-classifications using taxonomical-level textual data representative of one or more aspects of electronic transactions associated with the taxonomical pairs (e.g., using a clustering model). Such taxonomical-level textual data can be obtained, for instance, from web sites (e.g., scrubbed from merchant websites), entity transactional data, from a database, provided directly by entities herein, or otherwise obtained. For example, an entity can sell widgets. The clustering component 110 can make a determination that the entity sells widgets, for instance, by scrubbing the entity's website and analyzing the data scrubbed from the entity's website. Thus, respective taxonomical-level textual data associated with the entity can be determined (e.g., by the clustering component 110) to be associated with the sale of such widgets. In additional embodiments, such taxonomical-level textual data can be obtained by performing voice to text conversion, for instance, on support calls or other voice recordings associated with an entity.

It is noted that an entity classification of the entity classifications can be associated with respective industry data representative of a high-level description of respective entity operations. Nonlimiting examples of such entity classifications can comprise, for instance, vehicle service and accessories, clothing, accessories, and shoes, arts, crafts, and collectibles, home & garden, non-profit, political, and religion, or other suitable entity classifications. Likewise, a sub-classification of the sub-classifications can be associated with respective sub-industry data representative of a low-level description of respective entity operations. For instance, sub-classifications of vehicle service and accessories can comprise one or more of new parts and supplies, service, used parts, or other sub-classifications. In this regard, initial clusters of taxonomical pairs can be determined (e.g., by the clustering component 110) based on the industry data and the sub-industry data. In various embodiments, aspects of the electronic transactions can comprise one or more of TPV (e.g., over a defined period of time, such as twenty four months), industry description (e.g., high-level description of merchants' respective industry description, such as clothing, travel, sports and outdoors), sub-industry description (e.g., low-level description provides more details, such as baby clothing and supplies, lodging/hotels, motels, and resorts), region, consumer demographics, web traffic, website text, goods or services sold, transactional data, speech-to-text conversions, market segment, or other suitable aspects of electronic transactions. It is noted that initial clusters herein can comprise foundational clusters on which clustering refinement (e.g., by the refinement component 114 as later discussed in greater detail) can be performed.

In various embodiments, the clustering component 110 can determine an industry description by performing a text-cleaning operation (e.g., removing punctuation and/or stop words). For example, the clustering component 110 can access an entity's website or other suitable text-based documents or information, and perform the text-cleaning prior on the taxonomical-level textual data, which can improve accuracy of the generation of initial clusters (e.g., by the clustering component 110) of taxonomical pairs of entity classifications and entity sub-classifications.

In another embodiment, the clustering component 110 can cluster (e.g., using a clustering model herein) vector representations of taxonomical pairs of entity classifications and entity sub-classifications using taxonomical-level textual data representative of one or more aspects of electronic transactions associated with the taxonomical pairs, resulting in initial clusters of the taxonomical pairs. In further embodiments, the clustering component 110 can apply vector representations of taxonomical-level textual data, representative of one or more aspects of electronic transactions associated with taxonomical pairs of entity classifications and entity sub-classifications, as input to the clustering model to obtain initial clusters of taxonomical pairs. It is noted that the clustering component 110 can be configured to convert the taxonomical-level textual data into such vector representations. In this regard, the clustering component 110 can cluster vector representations of the taxonomical-level textual data generated using a natural language processing (NLP) function. For instance, such an NLP function can utilize global vectors for word representation (GloVe) word embeddings. In this regard, the clustering component 110 can apply a GloVe word representation using the NLP function to convert each word (e.g., of taxonomical-level textual data) into a numeric vector, and then calculate the averaged numeric vector across all words in an entity classification.

In various embodiments, clustering the vector representations of the taxonomical pairs can comprise clustering (e.g., by the clustering component 110), using a K-means clustering algorithm, the vector representations of the taxonomical pairs. For instance, K-means clustering can be utilized (e.g., by the clustering component 110 and/or machine learning component 112 as later discussed herein) to partition data into K-clusters. In this regard, K can comprise the parameter that a system or component herein, or a user of a system herein, specifies prior to executing the K-means algorithm. It is noted that K-means algorithms herein can be utilized, for instance, for grouping similar data points together and/or to discover underlying patterns in data (e.g., the taxonomical-level textual data).

According to an embodiment, the clustering component 110 can exclude a taxonomical pair and/or associated entities from inclusion in the initial clusters, for instance, when respective operational parameter data of the taxonomical pair or associated entities are determined not to satisfy a defined operational parameter data threshold. According to an example, the defined operational parameter data threshold can be representative of a monthly TPV threshold. In this regard, an excluded taxonomical pair can comprise a monthly TPV below the monthly TPV threshold. It is noted that the excluded taxonomical pair or entities can be “set aside” for later inclusion in a cluster herein (e.g., a refined cluster or sub-cluster). It is further noted that, by excluding low-TPV industries from initial clusters, noise in initial entity clustering can be reduced. According to an example, certain industries (e.g., gambling) can comprise a smaller quantity of merchants (e.g., relative to other industries), and thus preventing such merchants from inclusion (e.g., by the clustering component 110) in initial clustering can reduce the introduction of noise into the initial clustering process. It is noted that the clustering component 110 can later assign an excluded taxonomical pair to a tuned cluster of tuned clusters (later discussed in greater detail) using, for instance, respective taxonomical-level textual data of the excluded taxonomical pair and a cosine similarity metric determined to be threshold-satisfied by the excluded taxonomical pair and the tuned cluster.

In various embodiments, the aforementioned clustering model can be generated based on machine learning (e.g., using the M.L. component 112) applied to past clusters of past taxonomical pairs of entity classifications and entity sub-classifications other than the initial clusters of the taxonomical pairs. For example, the M.L. component 112 can access a database comprising past taxonomical pairs of entity classifications and entity sub-classifications. The M.L. component 112 can thereby utilize M.L. and/or artificial intelligence (A.I.). in order to generate a clustering model based on the past taxonomical pairs of classifications and sub-classifications of entities. The clustering model can therefore be utilized (e.g., by the clustering component 110) in the initial clustering of entities herein.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or M.L. components (e.g., M.L. component 112) herein can comprise artificial intelligence component(s) which can employ an artificial intelligence (AI) model and/or M.L. or an M.L. model that can learn to perform the above or below described functions (e.g., via training using historical training data and/or feedback data).

In some embodiments, M.L. component 112 can comprise an A.I. and/or M.L. model that can be trained (e.g., via supervised and/or unsupervised techniques) to perform the above or below-described functions using historical training data comprising various context conditions that correspond to various management operations. In this example, such an A.I. and/or M.L. model can further learn (e.g., via supervised and/or unsupervised techniques) to perform the above or below-described functions using training data comprising feedback data, where such feedback data can be collected and/or stored (e.g., in memory) by an M.L. component 112. In this example, such feedback data can comprise the various instructions described above/below that can be input, for instance, to a system herein, over time in response to observed/stored context-based information.

A.I./M.L. components herein can initiate an operation(s) associated with a based on a defined level of confidence determined using information (e.g., feedback data). For example, based on learning to perform such functions described above using feedback data, performance information, and/or past performance information herein, an M.L. component 112 herein can initiate an operation associated with entity clustering. In another example, based on learning to perform such functions described above using feedback data, an M.L. component 112 herein can initiate an operation associated with updating a model (e.g., a tuning model herein).

In an embodiment, the M.L. component 112 can perform a utility-based analysis that factors cost of initiating the above-described operations versus benefit. In this embodiment, an artificial intelligence component can use one or more additional context conditions to determine an appropriate distance threshold or context information, or to determine an update for a tuning model.

To facilitate the above-described functions, an M.L. component herein can perform classifications, correlations, inferences, and/or expressions associated with principles of artificial intelligence. For instance, an M.L. component 112 can employ an automatic classification system and/or an automatic classification. In one example, the M.L. component 112 can employ a probabilistic and/or statistical-based analysis (e.g., factoring into the analysis utilities and costs) to learn and/or generate inferences. The M.L. component 112 can employ any suitable machine-learning based techniques, statistical-based techniques and/or probabilistic-based techniques. For example, the M.L. component 112 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the M.L. component 112 can perform a set of machine-learning computations. For instance, the M.L. component 112 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

According to an embodiment, the refinement component 114 can iteratively refine the initial clusters (e.g., according to a similarity criterion, such as an intracluster similarity criterion) resulting in tuned clusters. It is noted that iteratively refining the initial clusters can comprise iteratively refining the initial clusters using binary clustering until data representative of an aspect of intracluster similarity of the one or more aspects of the electronic transactions within a cluster is determined to satisfy the defined intracluster similarity threshold. Such aspects of the electronic transactions can comprise, for instance, one or more of TPV (e.g., over a defined period of time, such as twenty four months), industry description (e.g., high-level description of merchants' respective industry description, such as clothing, travel, sports and outdoors), sub-industry description (e.g., low-level description provides more details, such as baby clothing and supplies, lodging/hotels, motels, and resorts), region, consumer demographics, web traffic, website text, goods or services sold, transactional data, speech-to-text conversions, market segment, or other suitable aspects of electronic transactions. In further embodiments, the refinement component 114 can iteratively refine the initial clusters to generate the tuned clusters by applying vector representations of the one or more aspects of the electronic transactions as input for a K-means clustering algorithm with a cluster size set for binary clustering. In additional embodiments, the refinement component 114 can iteratively refine the initial clusters to generate the tuned clusters by iteratively refining using binary clustering, for instance, until data representative of an aspect of intracluster similarity of the one or more aspects of the electronic transactions exceeds a defined intracluster similarity threshold. In this regard, the initial clusters can be divided (e.g., by the refinement component 114, into sub-clusters (e.g., tuned clusters). In various embodiments, the tuned clusters can replace the initial clusters. In further embodiments, the refinement component 114 can iteratively refine the initial clusters to generate the tuned clusters using Pearson correlation coefficients computed using the one or more aspects of the electronic transactions. For example, an initial cluster can be refined (e.g., by the refinement component 114) according to a TPV trend. In this regard, the initial cluster(s) can be tuned such that entities/industries in the same cluster can comprise a similar TPV trend. For instance, monthly TPV can be scaled and converted into numeric vectors (e.g., for each industry). K-means clustering can be utilized to keep dividing into binary clusters (e.g., cluster size two) starting from initial clusters. Binary clustering can be discontinued, for instance, when a Pearson correlation coefficient on TPV vectors between any industry in a common cluster satisfy a threshold (e.g., greater than a defined intracluster similarity threshold).

It is noted that, in some embodiments, the clustering component 110 can assign an excluded taxonomical pair to a tuned cluster of tuned clusters using respective taxonomical-level textual data of the excluded taxonomical pair and a cosine similarity metric determined to be threshold-satisfied by the excluded taxonomical pair and the tuned cluster. In this regard, an excluded taxonomical pair can be reassigned to a cluster herein (e.g., an existing cluster). The foregoing can enable more complete inclusion of taxonomical pairs, while reducing the introduction of noise into the clustering process.

According to an embodiment, the removal component 116 can remove a tuned cluster from the tuned clusters when a quantity of entities associated with one or more of the taxonomical pairs represented in the tuned cluster is determined to satisfy a defined taxonomical pair removal threshold. For example, the defined taxonomical pair removal threshold can comprise a minimum quantity of entities represented in a tuned cluster. The foregoing can prevent utilization of tuned clusters that are too granular and thus do not cluster a sufficient defined quantity of entities together. In this regard, the defined quantity of entitles can comprise four entities, five entities, ten entities, or another suitable quantity of entities. The defined taxonomical pair removal threshold can vary by industry and/or can be determined using machine learning (e.g., by the M.L. component 112) herein.

According to an embodiment, the mapping component 118 can generate a cluster map (e.g., cluster map 320) based on the tuned clusters and entity-level textual data associated with the one or more aspects of the electronic transactions associated with an entity represented in the taxonomical pairs. Such a cluster map 320 can comprise a visual representation (e.g., for display on a graphical user interface) of tuned clusters of entities herein. The cluster map 320 can, for instance, be provided on a GUI of a system herein or communicatively coupled to a system herein. For example, Entity 1, Entity 2, Entity 3, Entity 4, and Entity 5 can be members of Cluster A. Similarly, Entity 6, Entity 7, Entity 8, Entity 9, and Entity 20 can be members of Cluster B. Likewise, Entity 11, Entity 12, Entity 13, Entity 14, and Entity 15 can be members of Cluster C. The foregoing can be displayed in the cluster map 320 which can promote improved visualization of clusters and member entities herein.

According to an embodiment, the quantity component 120 can determine a quantity of entities associated with a set of taxonomical pairs of a tuned cluster of the tuned clusters. In this regard, the clustering component 110 can remove the tuned cluster from the tuned clusters when the quantity of entities is determined, by the system, not to satisfy a defined quantity threshold. For instance, the quantity component 120 can determine a quantity of merchants in a cluster and, if the quantity of merchants in a cluster is less than a defined threshold, remove the cluster or prevent the tuned cluster from inclusion in a group of tuned clusters. The foregoing can filter out cluster(s) below a defined threshold quantity of entities or merchants, which can help ensure that clusters have a sufficient defined quantity of merchants. It is noted that removed clusters, merchants, and/or associated industries can be later re-assigned to other clusters (e.g., by the clustering component 110). In this regard, the clustering component can re-assign the removed clusters, merchants, and/or associated industries to a cluster comprising a most-similar industry or sub-industry (e.g., that satisfies a cosine similarity criterion calculated based on industry description or other information).

According to an embodiment, the textual data component 122 can determine and/or generate the taxonomical-level textual data. In this regard, generating the taxonomical-level textual data can comprise aggregating (e.g., by the textual data component 122) entity-level textual data descriptive of a plurality of entities associated with the taxonomical pairs. According to an embodiment, the textual data can comprise keywords associated with a cluster. Such keywords can be stored, for instance, in a database of keywords. The keywords can be ranked (e.g., by the textual data component 122) from most populated (e.g., most represented) to least populated (e.g., least represented), or otherwise sorted. Keywords that most frequently appear (e.g., most populated or represented) can be considered the most relevant keywords for use in the taxonomical-level textual data.

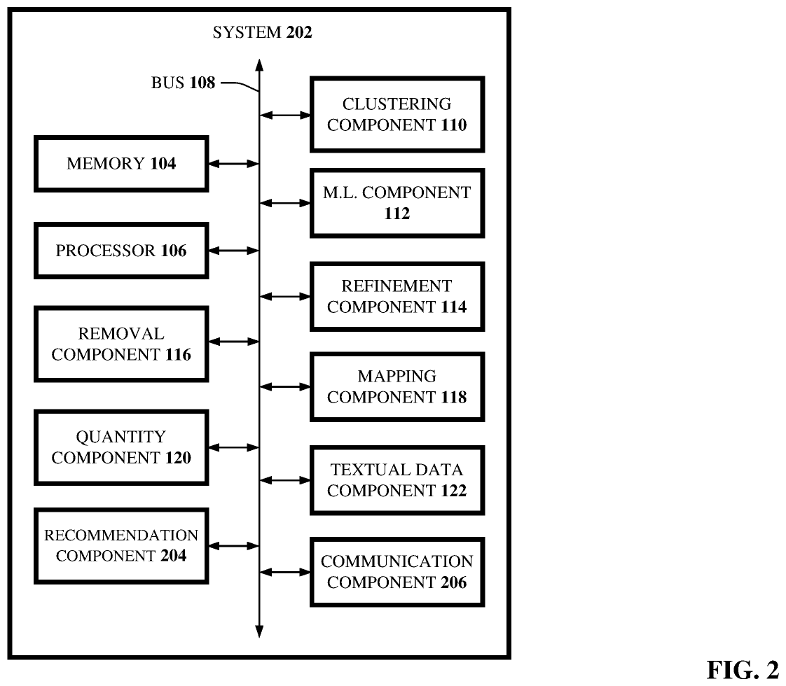

Turning now to FIG. 2, there is illustrated an example, non-limiting system 202 in accordance with one or more embodiments herein. System 202 can comprise a computerized tool, which can be configured to perform various operations relating to entity clustering. The system 202 can be similar to system 102, and can comprise one or more of a variety of components, such as memory 104, processor 106, bus 108, clustering component 110, machine learning (M.L.) component 112, refinement component 114, removal component 116, mapping component 118, quantity component 120, and/or textual data component 122. The system 202 can additionally comprise a recommendation component 204, and/or communication component 206.

In various embodiments, one or more of the memory 104, processor 106, bus 108, clustering component 110, machine learning (M.L.) component 112, refinement component 114, removal component 116, mapping component 118, quantity component 120, textual data component 122, recommendation component 204, and/or communication component 206, can be communicatively or operably coupled (e.g., over a bus or wireless network) to one another to perform one or more functions of the system 202.

According to an embodiment, the recommendation component 204 can generate a recommendation (e.g., based on the clustering by the clustering component 110 and/or refinement component 114). For example, a cluster herein can comprise a vehicle rental merchant (e.g., a first entity) and a vehicle repair merchant (e.g., a second entity). In this regard, the recommendation component 204 can determine that the vehicle rental merchant and vehicle repair merchant are located in a similar geographic area (e.g., within twenty miles of each other). The recommendation component 204 can further generate and/or send a recommendation associated with the determination that the vehicle rental merchant and vehicle repair merchant are located in a similar geographic area. For instance, such a recommendation can comprise a recommendation that the merchants collaborate with one another. In another example, such a recommendation can comprise a recommendation that the merchants communicate to one another (e.g., in some instances in the form of an advertisement). In further embodiments, the communication component 206 can automatically generate and/or send advertisement(s) between the vehicle rental merchant and the vehicle repair merchant. In this regard, the communication component 206 can generate an advertisement (e.g., an electronic advertisement or a physical advertisement) for an entity registered with the system 202 or clustered by the system 202. The communication component 206 can further send said advertisement (e.g., via e-mail, physical mail, social media, and/or via another suitable method) to a target recipient (e.g., another entity registered with the system 202 or clustered by the system 202).

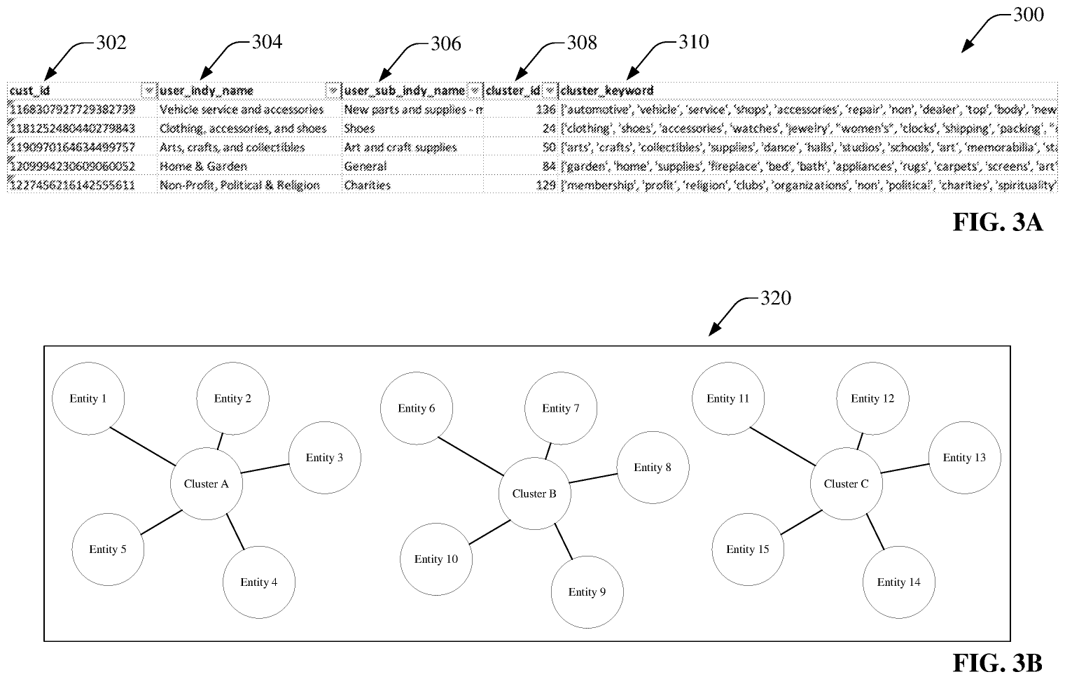

FIG. 3A illustrates exemplary clusters and associated information chart 300 in accordance with one or more embodiments described herein. For example, chart 300 can comprise an entity ID 302, entity or industry classification 304, sub-entity or sub-industry classification 306, cluster ID 308, and/or cluster keyword(s) 310. In this regard, an entity (e.g., merchant can comprise a unique entity ID 302. The entity ID 302 can be associated with an entity or industry classification 304 and/or a sub-entity or sub-industry classification 306. The entity ID 302 can be assigned, for instance, to a cluster 308. It is noted that cluster keyword(s) 310 can comprise various textual data associated with the entity ID 302 can be associated with an entity or industry classification 304 and/or a sub-entity or sub-industry classification 306. The foregoing can be utilized (e.g., by mapping component 118) to generate a cluster map 320 as previously described herein.

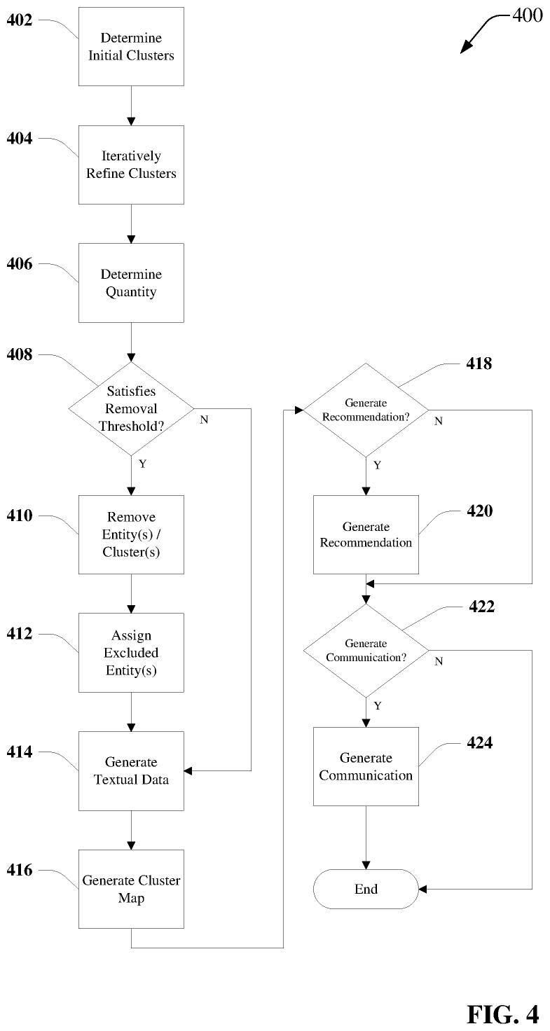

Turning now to FIG. 4, there is illustrated a flowchart of a process 400 for entity clustering in accordance with one or more embodiments herein. At 402, the process 400 can comprise determining (e.g., using a clustering component 110 and based on a clustering model) initial clusters of taxonomical pairs of entity classifications and entity sub-classifications using taxonomical-level textual data representative of one or more aspects of electronic transactions associated with the taxonomical pairs. At 404, the process 400 can comprise iteratively refining (e.g., using a refinement component 114) the initial clusters, according to a similarity criterion, resulting in tuned clusters. At 406, the process 400 can comprise determining (e.g., using a quantity component 120) a quantity of entities associated with one or more of the taxonomical pairs represented in the tuned cluster. At 408, the process 400 can comprise determining (e.g., using a removal component 116) whether the quantity of entities satisfies a defined taxonomical pair removal threshold. If the quantity satisfies the removal threshold, the process can proceed to 410. If the quantity does not satisfy the removal threshold, the process can proceed to 414. At 410 the entities and/or clusters associated with the entity can be removed. At 412, the excluded entities (e.g., taxonomical pairs) can be assigned (e.g., using the clustering component 110 and/or refinement component 114) to different cluster(s). At 414, textual data associated with one or more clusters can be generated or determined (e.g., using the textual data component 122). At 416, a cluster map can be generated (e.g., by the mapping component 118). At 418, if a recommendation is to be generated, the process can proceed to 420. Otherwise, the process can proceed to 422. At 420, a recommendation can be generated. At 422, if communication is to be generated (such as an advertisement), the process can proceed to 424. Otherwise, the process can end (or repeat at 402). At 424, a communication can be generated (e.g., by the communication component 206). Afterward, the process can end (or repeat at 402).

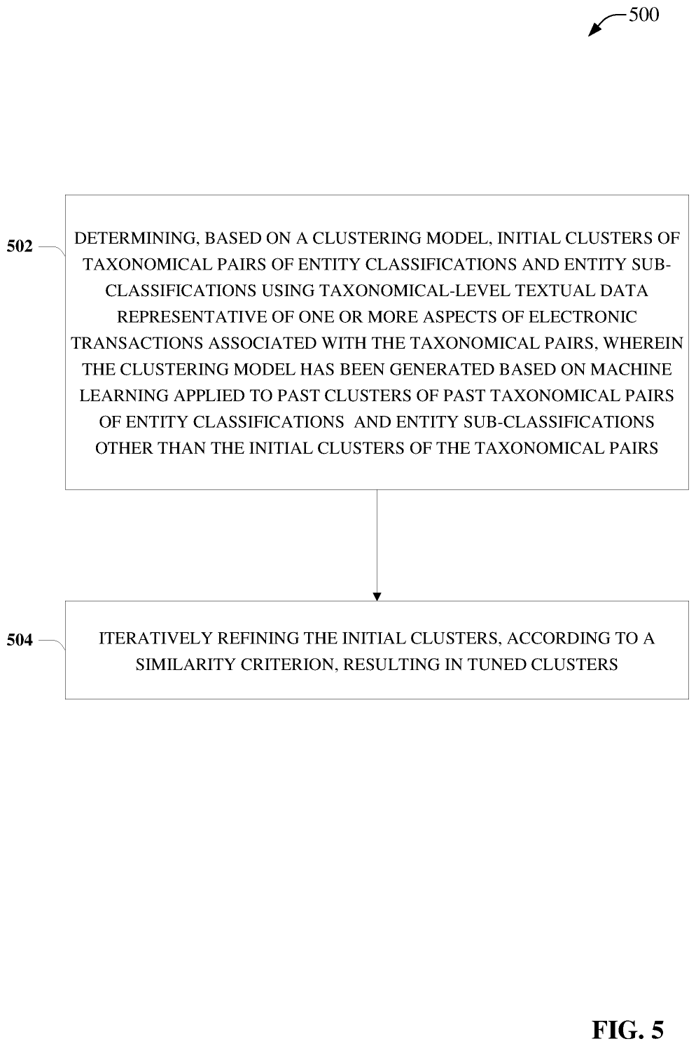

FIG. 5 illustrates a block flow diagram for a process 500 for entity clustering in accordance with one or more embodiments described herein. At 502, the process 500 can comprise determining (e.g., using a clustering component 110), based on a clustering model, initial clusters of taxonomical pairs of entity classifications and entity sub-classifications using taxonomical-level textual data representative of one or more aspects of electronic transactions associated with the taxonomical pairs, wherein the clustering model has been generated based on machine learning (e.g., by the M.L. component 112) applied to past clusters of past taxonomical pairs of entity classifications and entity sub-classifications other than the initial clusters of the taxonomical pairs. At 504, the process 500 can comprise iteratively refining the initial clusters (e.g., by the refinement component 114), according to a similarity criterion, resulting in tuned clusters.

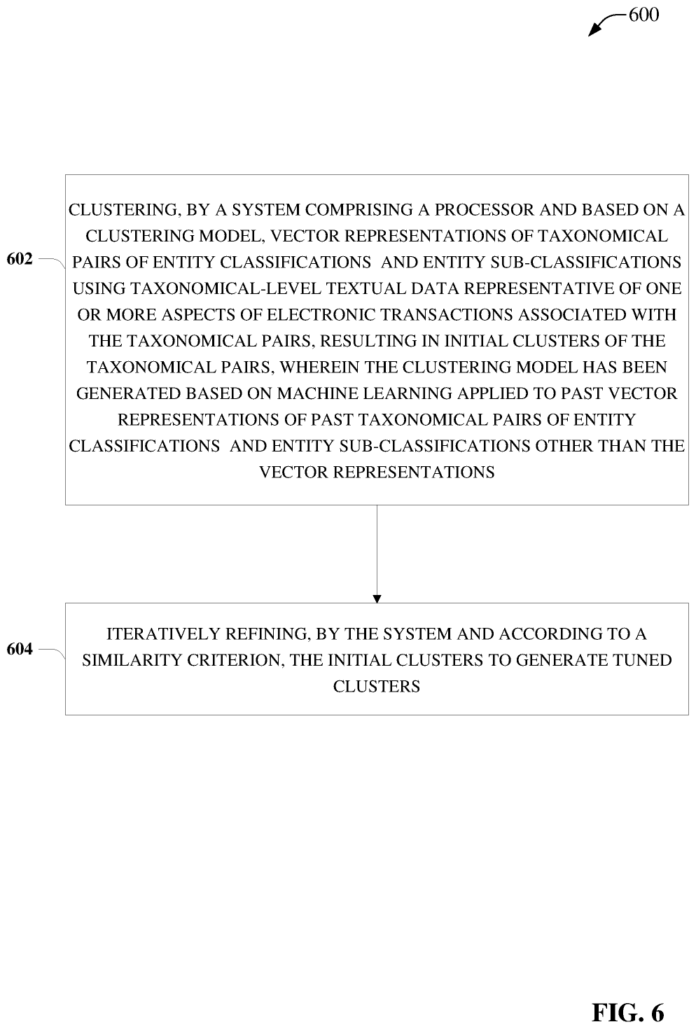

FIG. 6 illustrates a block flow diagram for a process 600 for entity clustering in accordance with one or more embodiments described herein. At 602, the process 600 can comprise clustering, by a system comprising a processor (e.g., using a clustering component 110) and based on a clustering model, vector representations of taxonomical pairs of entity classifications and entity sub-classifications using taxonomical-level textual data representative of one or more aspects of electronic transactions associated with the taxonomical pairs, resulting in initial clusters of the taxonomical pairs, wherein the clustering model has been generated based on machine learning (e.g., using the M.L. component 112) applied to past vector representations of past taxonomical pairs of entity classifications and entity sub-classifications other than the vector representations. At 604, the process 600 can comprise iteratively refining, by the system and according to a similarity criterion (e.g., using the refinement component 114), the initial clusters to generate tuned clusters.

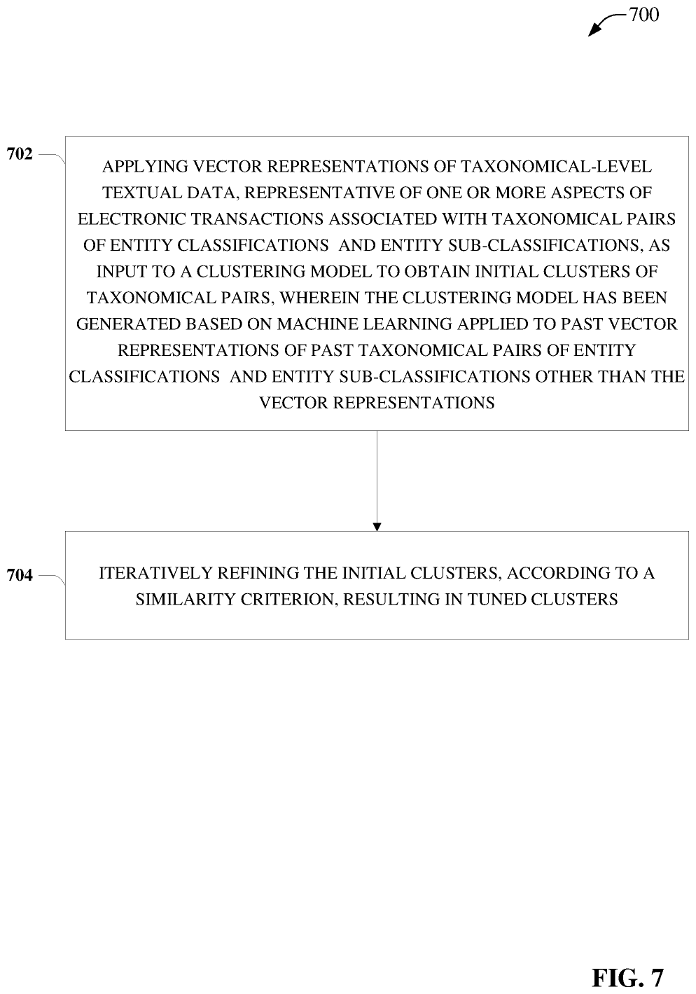

FIG. 7 illustrates a block flow diagram for a process 700 for entity clustering in accordance with one or more embodiments described herein. At 702, the process 700 can comprise applying (e.g., using the clustering component 110) vector representations of taxonomical-level textual data, representative of one or more aspects of electronic transactions associated with taxonomical pairs of entity classifications and entity sub-classifications, as input to a clustering model to obtain initial clusters of taxonomical pairs, wherein the clustering model has been generated based on machine learning (e.g., using the M.L. component 112) applied to past vector representations of past taxonomical pairs of entity classifications and entity sub-classifications other than the vector representations. At 704, the process 700 can comprise iteratively refining the initial clusters (e.g., using the refinement component 114), according to a similarity criterion, resulting in tuned clusters.

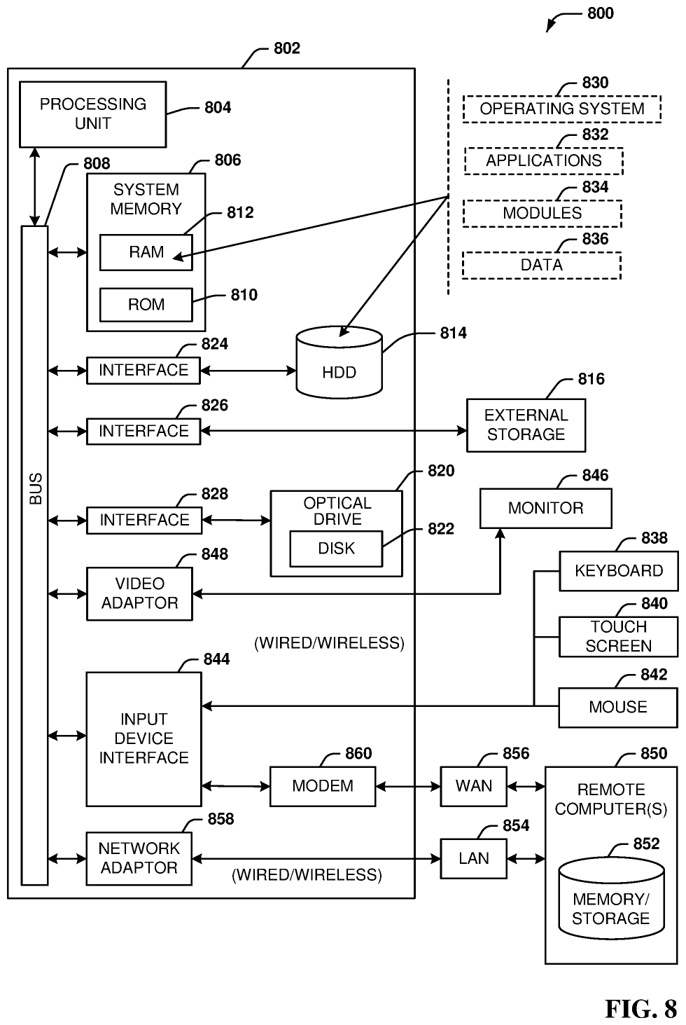

In order to provide additional context for various embodiments described herein, FIG. 8 and the following discussion are intended to provide a brief, general description of a suitable computing environment 800 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 8, the example environment 800 for implementing various embodiments of the aspects described herein includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), one or more external storage devices 816 (e.g., a magnetic floppy disk drive (FDD) 816, a memory stick or flash drive reader, a memory card reader, etc.) and an optical disk drive 820 (e.g., which can read or write from a CD-ROM disc, a DVD, a BD, etc.). While the internal HDD 814 is illustrated as located within the computer 802, the internal HDD 814 can also be configured for external use in a suitable chassis (not shown). Additionally, while not shown in environment 800, a solid-state drive (SSD) could be used in addition to, or in place of, an HDD 814. The HDD 814, external storage device(s) 816 and optical disk drive 820 can be connected to the system bus 808 by an HDD interface 824, an external storage interface 826 and an optical drive interface 828, respectively. The interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 812, including an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the .NET framework, for applications 832. Runtime environments are consistent execution environments that allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and settings for an application.

Further, computer 802 can be enable with a security module, such as a trusted processing module (TPM). For instance, with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 1394 serial port, a game port, a USB port, an IR interface, a BLUETOOTH® interface, etc.

A monitor 846 or other type of display device can be also connected to the system bus 808 via an interface, such as a video adapter 848. In addition to the monitor 846, a computer typically includes other peripheral output devices (not shown), such as speakers, printers, etc.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 852 is illustrated. The logical connections depicted include wired/wireless connectivity to a local area network (LAN) 854 and/or larger networks, e.g., a wide area network (WAN) 856. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the local network 854 through a wired and/or wireless communication network interface or adapter 858. The adapter 858 can facilitate wired or wireless communication to the LAN 854, which can also include a wireless access point (AP) disposed thereon for communicating with the adapter 858 in a wireless mode.

When used in a WAN networking environment, the computer 802 can include a modem 860 or can be connected to a communications server on the WAN 856 via other means for establishing communications over the WAN 856, such as by way of the Internet. The modem 860, which can be internal or external and a wired or wireless device, can be connected to the system bus 808 via the input device interface 844. In a networked environment, program modules depicted relative to the computer 802 or portions thereof, can be stored in the remote memory/storage device 852. It will be appreciated that the network connections shown are example and other means of establishing a communications link between the computers can be used.

When used in either a LAN or WAN networking environment, the computer 802 can access cloud storage systems or other network-based storage systems in addition to, or in place of, external storage devices 816 as described above. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

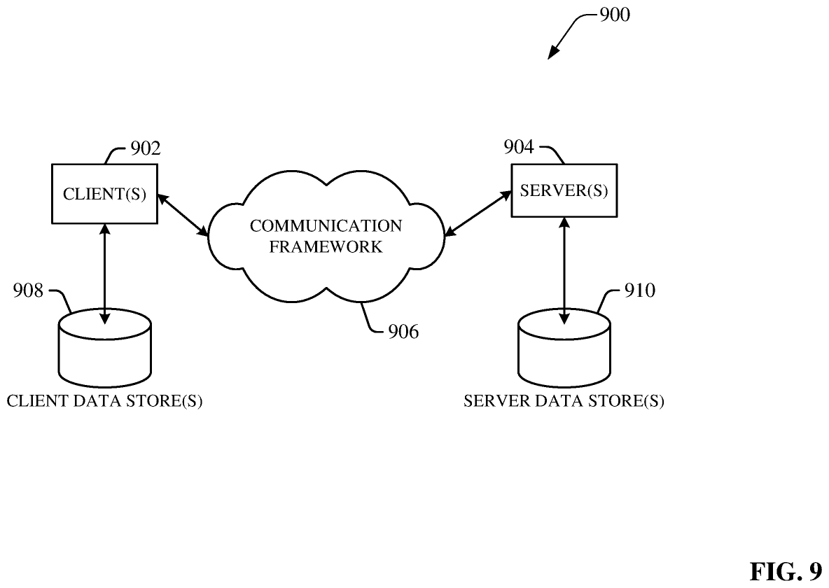

Referring now to FIG. 9, there is illustrated a schematic block diagram of a computing environment 900 in accordance with this specification. The system 900 includes one or more client(s) 902, (e.g., computers, smart phones, tablets, cameras, PDA's). The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware or hardware in combination with software (e.g., threads, processes, computing devices). The servers 904 can house threads to perform transformations of media items by employing aspects of this disclosure, for example. One possible communication between a client 902 and a server 904 can be in the form of a data packet adapted to be transmitted between two or more computer processes wherein data packets may include coded analyzed headspaces and/or input. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

In one exemplary implementation, a client 902 can transfer an encoded file, (e.g., encoded media item), to server 904. Server 904 can store the file, decode the file, or transmit the file to another client 902. It is noted that a client 902 can also transfer uncompressed file to a server 904 and server 904 can compress the file and/or transform the file in accordance with this disclosure. Likewise, server 904 can encode information and transmit the information via communication framework 906 to one or more clients 902.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a non-transitory computer-readable medium having stored thereon computer-executable instructions that are executable by the system to cause the system to perform operations comprising:
determining, based on a clustering model, initial clusters of taxonomical pairs of entity classifications and entity sub-classifications using taxonomical-level textual data representative of one or more aspects of electronic transactions associated with the taxonomical pairs, wherein the clustering model has been generated based on machine learning applied to past clusters of past taxonomical pairs of entity classifications and entity sub-classifications other than the initial clusters of the taxonomical pairs; and
iteratively refining the initial clusters, according to a similarity criterion, resulting in tuned clusters.

2. The system of claim 1, wherein determining the initial clusters of the taxonomical pairs comprises clustering vector representations of the taxonomical-level textual data generated using a natural language processing function.

3. The system of claim 1, wherein iteratively refining the initial clusters comprises iteratively refining the initial clusters using binary clustering until data representative of an aspect of intracluster similarity of the one or more aspects of the electronic transactions within a cluster is determined to satisfy a defined intracluster similarity threshold.

4. The system of claim 1, wherein
an entity classification of the entity classifications is associated with respective industry data representative of a high-level description of respective entity operations,
a sub-classification of the sub-classifications is associated with respective sub-industry data representative of a low-level description of respective entity operations, and
the initial clusters of the taxonomical pairs are determined based on the industry data and the sub-industry data.

5. The system of claim 1, wherein an aspect of the one or more aspects of the electronic transactions associated with the taxonomical pairs comprises periodic transaction volume data representative of periodic transaction volume associated with the taxonomical pairs.

6. The system of claim 1, wherein the operations further comprise:
excluding a taxonomical pair from the initial clusters when respective operational parameter data of the taxonomical pair is determined not to satisfy a defined operational parameter data threshold.

7. The system of claim 1, wherein the operations further comprise:
removing a tuned cluster from the tuned clusters when a quantity of entities associated with one or more of the taxonomical pairs represented in the tuned cluster is determined to satisfy a defined taxonomical pair removal threshold.

8. The system of claim 1, wherein the operations further comprise:
assigning an excluded taxonomical pair to a tuned cluster of the tuned clusters using respective taxonomical-level textual data associated with the excluded taxonomical pair and a cosine similarity criterion determined to be threshold-satisfied by the excluded taxonomical pair and the tuned cluster.

9. The system of claim 1, wherein the operations further comprise:
generating a cluster map based on the tuned clusters and entity-level textual data associated with the one or more aspects of the electronic transactions associated with an entity represented in the taxonomical pairs.

10. A computer-implemented method, comprising:
clustering, by a system comprising a processor and based on a clustering model, vector representations of taxonomical pairs of entity classifications and entity sub-classifications using taxonomical-level textual data representative of one or more aspects of electronic transactions associated with the taxonomical pairs, resulting in initial clusters of the taxonomical pairs, wherein the clustering model has been generated based on machine learning applied to past vector representations of past taxonomical pairs of entity classifications and entity sub-classifications other than the vector representations; and
iteratively refining, by the system and according to a similarity criterion, the initial clusters to generate tuned clusters.

11. The computer-implemented method of claim 10, wherein clustering the vector representations of the taxonomical pairs comprises clustering, by the system and using a K-means clustering algorithm, the vector representations of the taxonomical pairs.

12. The computer-implemented method of claim 10, wherein iteratively refining the initial clusters to generate the tuned clusters comprises applying, by the system, vector representations of the one or more aspects of the electronic transactions as input for a K-means clustering algorithm with a cluster size set for binary clustering.

13. The computer-implemented method of claim 10, wherein iteratively refining the initial clusters to generate the tuned clusters comprises iteratively refining, by the system, using binary clustering until data representative of an aspect of intracluster similarity of the one or more aspects of the electronic transactions exceeds a defined intracluster similarity threshold.

14. The computer-implemented method of claim 10, further comprising:
excluding, by the system, a taxonomical pair from inclusion in the initial clusters when respective operational parameter data of the taxonomical pair is determined not to satisfy a defined operational parameter data threshold.

15. The computer-implemented method of claim 10, further comprising:
determining, by the system, a quantity of entities associated with a set of taxonomical pairs of a tuned cluster of the tuned clusters; and
removing, by the system, the tuned cluster from the tuned clusters when the quantity of entities is determined, by the system, not to satisfy a defined quantity threshold.

16. The computer-implemented method of claim 10, further comprising:
generating, by the system, the taxonomical-level textual data, wherein generating the taxonomical-level textual data comprises aggregating, by the system, entity-level textual data descriptive of a plurality of entities associated with the taxonomical pairs.

17. The computer-implemented method of claim 10, further comprising:
assigning, by the system, an excluded taxonomical pair to a tuned cluster of the tuned clusters using respective taxonomical-level textual data of the excluded taxonomical pair and a cosine similarity metric determined to be threshold-satisfied by the excluded taxonomical pair and the tuned cluster.

18. A computer-program product comprising a computer-readable medium having program instructions embedded therewith, the program instructions executable by a computer system to cause the computer system to perform operations comprising:
applying vector representations of taxonomical-level textual data, representative of one or more aspects of electronic transactions associated with taxonomical pairs of entity classifications and entity sub-classifications, as input to a clustering model to obtain initial clusters of taxonomical pairs, wherein the clustering model has been generated based on machine learning applied to past vector representations of past taxonomical pairs of entity classifications and entity sub-classifications other than the vector representations; and
iteratively refining the initial clusters, according to a similarity criterion, resulting in tuned clusters.

19. The computer-program product of claim 18, wherein the operations further comprise:
iteratively refining the initial clusters to generate the tuned clusters using Pearson correlation coefficients computed using the one or more aspects of the electronic transactions.

20. The computer-program product of claim 18, the operations further comprise:
assigning an excluded taxonomical pair to a tuned cluster of the tuned clusters using respective taxonomical-level textual data of the excluded taxonomical pair and a cosine similarity metric determined to be threshold-satisfied by the excluded taxonomical pair and the tuned cluster.
